(19) United States
(12) Patent Application Publication
(10) Pub. No.: US 2017/0142162 A1
(43) Pub. Date: May 18, 2017

(54) Method, Network Element, Mobile Terminal, System and Computer Program Product for Cryptographic Algorithm Negotiation

(71) Applicant: NOKIA TECHNOLOGIES OY, Espoo (FI)

(72) Inventors: Dajiang Zhang, Beijing (CN); Silke Holtmanns, Klaukkala (FI)

(21) Appl. No.: 15/309,555

(22) PCT Filed: May 20, 2014
(86) PCT No.: PCT/CN2014/077868

§ 371 Date: Nov. 8, 2016

(51) Int. Cl. H04L 29/06; H04W 12/02

(52) U.S. Cl. CPC H04L 63/205; H04W 12/02; H04L 63/0428

(57) ABSTRACT

Method, network element, mobile terminal, system and computer program product are disclosed for negotiating cryptographic algorithm. The method comprises: receiving a first candidate list from the mobile terminal by the network element, wherein the first candidate list includes at least one candidate cryptographic algorithm supported by the mobile terminal and excludes at least one undesirable cryptographic algorithm even though it is supported by the mobile terminal; and selecting, from the first candidate list, a cryptographic algorithm supported by both the network element and the mobile terminal. As the undesirable cryptographic algorithm(s) is excluded from the first candidate list, the network element will be forced to choose more secure algorithms for communications with the mobile terminal.

### FIELD OF THE INVENTION

Embodiments of the disclosure generally relate to wireless communications, and, more particularly, to cryptographic algorithm negotiation in a wireless network.

### BACKGROUND

In a cellular network, eavesdropping, impersonation or modification attacks can be carried out over a relatively large area. The active stealing of calls is fairly easy, in principle, given the fact that the network has no real control over user movements. Thus, in the wireless communication systems, e.g. according to the global system for mobile communication (GSM) or Universal Mobile Telecommunications System (UMTS) standard, security is of utmost importance. It is now known that GSM systems suffer from security problems. For example, it is possible to retrieve the encryption key by breaking the A5/2 confidentiality algorithm. Currently, A5/1 is badly broken. For example, a communication protected by A5/1 can be listened in in real-time. There are indications of widespread eavesdropping by intelligence agencies, and some criminal exploits as well.

In general, the procedure of cryptographic algorithm negotiation in wireless communication systems is as follow: a mobile terminal signals its capabilities including all the cryptographic algorithms it supports, to a network element; the network element then selects which cryptographic algorithm to use.

In order to improve the security level in the wireless communications, a possible way, for example, is to upgrade all the relevant network infrastructures and mobile terminals to eliminate poor cryptographic algorithms and support suitable newer cryptographic algorithms. For example, in its recent release, the 3GPP has made the stronger confidentiality algorithms A5/3 and A5/4 mandatory in both mobile terminals and networks. The GSM Association (GSMA) has also required eliminating support for A5/1 in mobile terminals and networks. However, this may encounter some barriers. For example, some network operators are reluctant to upgrade their networks due to heavy costs or less incentive to replace the “older technology”. Moreover, terminal manufactures may also refuse to do so, because the compliant terminals may be unable to work in some old networks and the user then may suddenly face the situation that his phone does not work. This is very bad for a terminal manufacturer, since the “not working” terminals are returned (on the manufacturer's costs) and other manufacturers may continue selling their non-compliant terminals, which leads to market share loss of the compliant manufacturer. Further, it is possible that some mobile terminals have been upgraded to support newer cryptographic algorithms while some networks have not been upgraded. In this case, the mobile terminals that have eliminated poor cryptographic algorithms may loss protection in those non-upgraded networks.

Embedded UICCs (Universal Integrated Circuit Cards) and the corresponding baseband chip might be in the field for much longer than mobile terminals. Machines (machine-to-machine, Internet of things) are expected to be in the field up to 20 years. During this period of time cryptographic algorithms may become weak substantially. The complete over-the-air replacement of an algorithm might be challenging also due to support of legacy algorithms, but if a new algorithm is added and an old one is “labeled” undesirable, then the security of those machines would be improved.

Therefore, it is desirable to provide an enhanced cryptographic algorithm negotiation to maximize the security protection, while still having preserving compatibility with older terminals and networks.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided a method for cryptographic algorithm negotiation between a network element and a mobile terminal. The method comprises: receiving a first candidate list from the mobile terminal by the network element, wherein the first candidate list includes at least one candidate cryptographic algorithm supported by the mobile terminal and excludes at least one undesirable cryptographic algorithm even though it is supported by the mobile terminal; and selecting, from the first candidate list, a cryptographic algorithm supported by both the network element and the mobile terminal.

According to another aspect of the disclosure, it is provided a network element. The network element comprises: a receiving means configured to receive a first candidate from a mobile terminal, wherein the first candidate list includes at least one candidate cryptographic algorithm supported by the mobile terminal and excludes at least one undesirable cryptographic algorithm even though it is supported by the mobile terminal; a sending means configured to send a first message indicating a default cryptographic setting to the mobile terminal if the network element does not support any cryptographic algorithm in the first candidate list; and a resending means configured to send a third message to the mobile terminal after receiving a second message rejecting the default cryptographic setting from the mobile terminal, wherein the third message indicates a cryptographic algorithm selected from said at least one undesirable cryptographic algorithm excluded in the first candidate list, which is supported by both the network element and the mobile terminal.

According to still another aspect of the disclosure, it is provided a network element. The network element comprises: at least one processor; and at least one memory including computer program code, wherein the at least one memory and the computer program code are configured to, with the at least one processor, cause the network element to: receive a first candidate from a mobile terminal, wherein the first candidate list includes at least one candidate cryptographic algorithm supported by the mobile terminal and excludes at least one undesirable cryptographic algorithm even though it is supported by the mobile terminal; send a first message indicating a default cryptographic setting to the mobile terminal if the network element does not support any cryptographic algorithm in the first candidate list; and send a third message to the mobile terminal after receiving a second message rejecting the default cryptographic setting from the mobile terminal, wherein the third message indicates a cryptographic algorithm selected from said at least one undesirable cryptographic algorithm excluded in the first candidate list, which is supported by both the network element and the mobile terminal.

According to still another aspect of the disclosure, it is provided a mobile terminal. The mobile terminal comprises: a sending means configured to send a first candidate list to a network element, wherein the first candidate list includes at least one candidate cryptographic algorithm supported by the mobile terminal and excludes at least one undesirable cryptographic algorithm even though it is supported by the mobile terminal.

According to still another aspect of the disclosure, it is provided a mobile terminal. The mobile terminal comprises: at least one processor; and at least one memory including computer program code, wherein the at least one memory and the computer program code are configured to, with the at least one processor, cause the mobile terminal to: send a first candidate list to a network element, wherein the first candidate list includes at least one candidate cryptographic algorithm supported by the mobile terminal and excludes at least one undesirable cryptographic algorithm even though it is supported by the mobile terminal.

According to still another aspect of the present disclosure, it is provided a system. The system comprising: a network element as described above and at least one mobile terminal as described above.

According to still another aspect of the present disclosure, it is provided a computer program product comprising at least one non-transitory computer-readable storage medium having computer-executable program instructions stored therein, the computer-executable instructions being configured to, when being executed, cause a network element to operate as described above.

According to still another aspect of the present disclosure, it is provided a computer program product comprising at least one non-transitory computer-readable storage medium having computer-executable program instructions stored therein, the computer-executable instructions being configured to, when being executed, cause a mobile terminal to operate as described above.

These and other objects, features and advantages of the disclosure will become apparent from the following detailed description of illustrative embodiments, which are to be read in connection with the accompanying drawings.

### BRIEF DESCRIPTION OF THE DRAWINGS

FIG. 1 is a simplified block diagram illustrating a wireless system according to an embodiment;

FIG. 2 is a diagram depicting the process of negotiating cryptographic algorithm in a wireless network according to an embodiment;

FIG. 3 is a diagram depicting the process of negotiating cryptographic algorithm in a wireless network according to another embodiment;

FIG. 4 is a diagram depicting the process of negotiating cryptographic algorithm in a wireless network according to still another embodiment;

FIG. 5 is a diagram depicting part of the process of negotiating cryptographic algorithm in a wireless network according to still another embodiment;

FIG. 6 is a simplified block diagram illustrating a network element according to an embodiment; and

FIG. 7 is a simplified block diagram illustrating a mobile terminal according to an embodiment.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

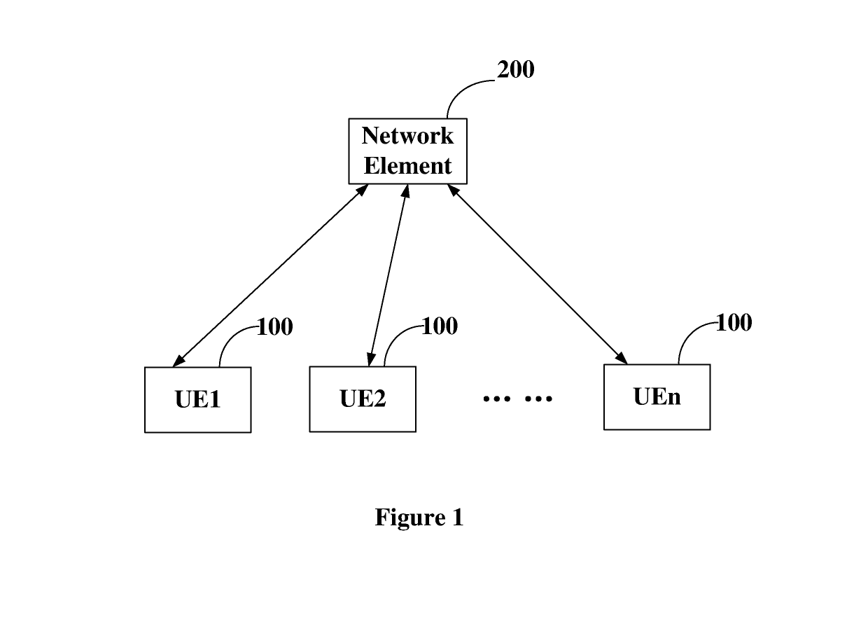

FIG. 1 shows a wireless system according to an embodiment. While this and other embodiments below are primarily discussed in the context of a GSM network, it will be recognized by those of ordinary skill that the disclosure is not so limited. In fact, the various aspects of this disclosure are useful in any wireless network that can benefit from the enhenced cryptographic algorithm negotiation as is described herein, such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma1000, etc. UTRA includes Wideband CDMA (WCDMA) and other variants of CDMA. cdma1000 covers IS-1000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc.

As shown in FIG. 1, the wireless system comprises a network element 200 and a plurality of user equipments (mobile terminals) 100. The network element 200 refers to function elements on the network side as compared to the mobile terminals. For example, the network element 200 may comprise a serving base station system (BSS) having a base station controller (BSC) and one or more base transceiver stations (BTSs), and a mobile services switching center (MSC). The solid lines with double arrows indicate desired transmissions between the mobile terminals and the network element on the downlink and uplink. It is well known that a cellular radio system comprises a network of radio cells each served by a transmitting station, known as a cell site or base transceiver station. The radio network provides wireless communications service for a plurality of transceivers (in most cases mobile). The network of BSS working in collaboration allows for wireless service which is greater than the radio coverage provided by a single BSS. The individual BSS are connected by another network (in many cases a wired network, not shown), which includes additional controllers for resource management and in some cases access to other network systems (such as the Internet) or MANs.

In a GSM system, the BSS includes a base station controller (BSC) and one or more base transceiver stations (BTSs), wherein the BSC is connected to mobile services switching center (MSC) (not shown). The GSM is the collective body of BSS along with MSC. A user interfaces to the GSM system via a user equipment (mobile terminal), which in many typical usage cases is a cellular phone or smartphone. As used herein, the terms “user equipment” and “mobile terminal” are interchangeably used and include, but not limited to, cellular telephones, smartphones, and computers, whether desktop, laptop, or otherwise, as well as mobile devices or terminals such as handheld computers, PDAs, video cameras, set-top boxes, personal media devices, or any combinations of the foregoing. The terms “mobile element” and “mobile terminal” are often used interchangeably. Further, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

In a GSM system, a plurality of cryptographic algorithms may be supported, such as A5/0, A5/1, A5/2, A5/3, A5/4, A5/5, A5/6, and A5/7. Among them, A5/0 is a non-encryption mode; A5/2 has been withdrew support due to its weakness; A5/1 is badly broken but mainly used; A5/3 is stronger than A5/1 but still based on 64-bit key and thus not unbreakable; A5/4 is based on 128-bit key and stronger than A5/3. GSM has also a range of integrity algorithms.

The cryptographic negotiation procedure in a GSM system has been described in, inter alia, GSM Technical Specification 08.08 entitled “Mobile-services Switching Centre—Base Station System (MSC—BSS) interface; Layer 3 specification”, which is incorporated herein by reference in its entirety. In summary, MSC and BSS work in concert to negotiation an appropriate cryptographic algorithm with each mobile terminal. This is achieved through CIPHER MODE COMMAND messages.

In the CIPHER MODE COMMAND, the MSC specifies which of the ciphering algorithms may be used by the BSS. The BSS then selects an appropriate algorithm, taking into account the mobile terminal's ciphering capabilities. The CIPHER MODE COMPLETE message returned to the MSC indicates the chosen ciphering algorithm. The set of permitted ciphering algorithms specified in the CIPHER MODE COMMAND shall remain applicable for subsequent Assignments and Intra-BSS Handovers. When the BSS receives the radio interface CIPHERING MODE COMPLETE from the mobile terminal, a CIPHER MODE COMPLETE message is returned to the MSC. If the BSS is unable to support the ciphering algorithm specified in the CIPHER MODE COMMAND message, then it shall return a CIPHER MODE REJECT message with Cause value “Ciphering algorithm not supported”. Moreover, the cryptographic negotiation procedures of the other wireless communication systems, such as UMTS, LTE, etc., are similar to the GSM.

Similarly, details of cryptographic negotiation in a 3G system are described in, inter alia, 3GPP TS 33.102 entitled “Technical Specification Group Services and System Aspects; 3G Security; Security architecture (Release 11)”, which is incorporated herein by reference in its entirety. Details of cryptographic negotiation in a 4G system are described in, inter alia, 3GPP TS 33.401 entitled “Technical Specification Group Services and System Aspects; 3GPP System Architecture Evolution (SAE); Security architecture (Release 12)”, which is incorporated herein by reference in its entirety. The terms “cryptography”, “cryptographic” and “encryption” are often used interchangeably, and generally refer to any techniques for secure communication in the presence of third parties including, but not limited to, encryption, ciphering, integrity protection, data encryption standard (DES), advanced encryption standard (AES), triple-DES, symmetric-key cryptography, stream ciphers, cryptographic hash functions, and public-key cryptography.

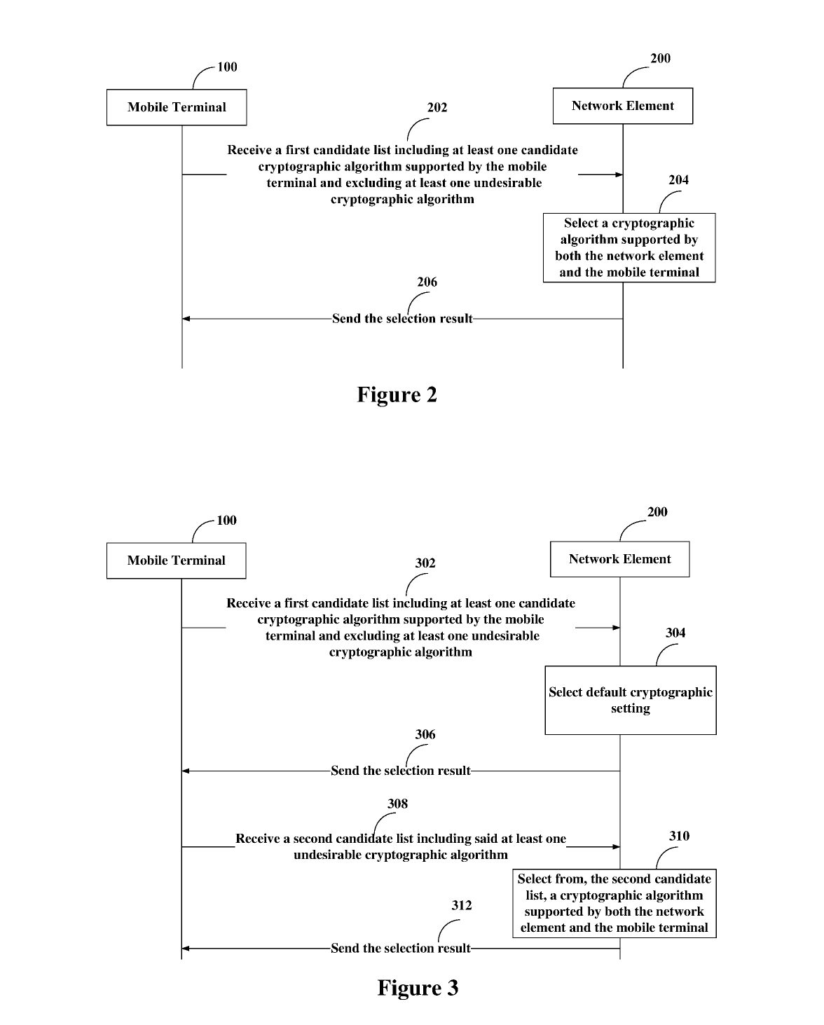

FIG. 2 is a diagram depicting the process of negotiating cryptographic algorithm in a wireless network according to an embodiment. As shown in FIG. 2, the process starts at step 202, wherein a mobile terminal 100 sends a first candidate list to the network element 200, wherein the first candidate list includes at least one candidate cryptographic algorithm supported by the mobile terminal 100 and excludes at least one undesirable cryptographic algorithm even though it is supported by the mobile terminal 100. In a GSM system, this can be done by starting the attach procedure while excluding the undesirable cryptographic algorithm (e.g. A5/1) from the mobile terminal's security capability list.

In this embodiment, the undesirable cryptographic algorithm(s) is one to be eliminated or restricted. According to another embodiment, the undesirable cryptographic algorithm may vary over time or when a mobile terminal moves to different networks. By way of example, a particular cryptographic algorithm can be defined as undesirable if that cryptographic algorithm has been badly broken or proven to be unreliable. It will be appreciated to those of ordinary skill in the art that there are other ways to define the undesirable cryptographic algorithm.

Further, an undesirable cryptographic algorithm can be predetermined in the mobile terminal. Alternatively, an undesirable cryptographic algorithm can be automatically designated from the network to which the mobile terminal has attached. It will be appreciated to those of ordinary skill in the art that there are other ways to designate an undesirable cryptographic algorithm.

Moreover, the designation of undesirable cryptographic algorithm can be updated after a predetermined period of time or at a certain interval. The designation of undesirable cryptographic algorithm can also be updated by changes in the context of the network, such as change of security policy, addition or deletion of cryptographic algorithms, etc. Furthermore, the undesirable cryptographic algorithms can be updated by changes in the context of the mobile terminal, such as, addition or deletion of cryptographic algorithms, etc. It will be appreciated to those of ordinary skill in the art that there are other ways to update the undesirable cryptographic algorithm.

In this embodiment, the first candidate list includes the candidate cryptographic algorithms supported by the mobile terminal other than the undesirable cryptographic algorithm(s) even though the undesirable cryptographic algorithm(s) is supported by the mobile terminal. For example, in a GSM system, if the mobile terminal supports A5/1, A5/3 and A5/4 and the undesirable cryptographic algorithm is A5/1, then the first candidate list will include A5/3 and A5/4.

At step 204, the network element 200 selects, from the first candidate list, a cryptographic algorithm supported by both the network element and the mobile terminal. In this embodiment, the network element may have information about what cryptographic algorithms are supported by the network element, i.e. the network side. This information can be obtained from the configuration information of the network and may be transferred between functional components in the network. For example, in a GSM system, the information is collected by the MSC and transferred to BSS as described in GSM Technical Specification 04.08. Assuming the first candidate list contains A5/3 and A5/4, and the network supports A5/3, then the network element 200 will select A5/3.

After the network element 200 has selected a cryptographic algorithm, the process proceeds to step 206, where the network element 200 informs the mobile terminal of the selection result. Thereafter, the mobile terminal 100 can use the selected cryptographic algorithm for communications with the network. In a GSM system, this can be done by sending a CIPHER MODE COMMAND indicating the selected algorithm from the network element 200, specifically, from MSC via BSS, to the mobile terminal 100.

As shown above, an undesirable cryptographic algorithm (e.g. A5/1) is excluded from the first candidate list and, thus, the network element 200 will not select and use it for communications with the mobile terminal 100. If every mobile terminal has adopted the above-described embodiments, the undesirable cryptographic algorithm can be eliminated in the network. Moreover, the above-described embodiment is a pure terminal solution and no modifications need to be made on the network side.

FIG. 3 is a diagram depicting the process of negotiating cryptographic algorithm in a wireless network according to another embodiment. As shown in FIG. 3, the process starts at step 302, where a mobile terminal 100 sends a first candidate list to a network element 200. The first candidate list includes at least one candidate cryptographic algorithm supported by the mobile terminal 100 and excludes at least one undesirable cryptographic algorithm even though it is supported by the mobile terminal 100. At step 204, the network element 200 attempts to select, from the first candidate list, a cryptographic algorithm supported by both the network element 200 and the mobile terminal 100.

The steps of 302 and 304 in this embodiment are similar to the steps 202 and 204 in FIG. 2. However, in this embodiment, the network element 200 cannot find a cryptographic algorithm supported by both the network element 200 and the mobile terminal 100 at step 404, because the network does not support any cryptographic algorithm in the first candidate list. Thus, the network element 200 selects a default cryptographic setting at step 304. The default cryptographic setting may vary among different networks, and may be changed by the configuration of a network. Then at step 306, the network element 200 informs the mobile terminal of the selection result. For example, in a GSM system, when the network does not support any cryptographic algorithm in the mobile terminal's security capability list, the default behavior of BSS and MSC is to set the ciphering algorithm to A5/0 (non-encryption) in the CIPER MODE COMMAND, for example, where the network only supports A5/1 and the first candidate list received from the mobile terminal 100 excludes A5/1.

When receiving the selection of default cryptographic setting, the mobile terminal 100 knows that the network element 200 does not support any cryptographic algorithm in the first candidate list. Thus, the mobile terminal 100 sends a second candidate list including said at least one undesirable cryptographic algorithm, for example A5/1, to the network element 200 at step 308. In a GSM system, this can be done by sending a CIPHER MODE REJECT MESSAGE from the mobile terminal 100 to the network element 200 and restarting the attach procedure with the undesirable cryptographic algorithm (e.g. A5/1) in the mobile terminal's security capability list. In some scenarios, the second candidate list may include multiple undesirable cryptographic algorithms, such as A5/1 and A5/2. It is noted that the embodiments of this disclosure can be applied to not only selection of confidentiality algorithms between cellular device and network, but authentication between eUICC/UICC and HLR/HSS or for integrity algorithms between cellular terminal and network. The algorithm selection for authentication is relevant for eUICC in particular, since there might be a choice of algorithms available due to the fact that the eUICC might be change operator.

Upon receiving the second candidate list, the network element 200 then selects, from the second candidate list, a cryptographic algorithm supported by both the network element and the mobile terminal at step 310. Then, the network element 200 sends the selection result to the mobile terminal 100 at 312. Thereafter, the mobile terminal 100 can use the selected cryptographic algorithm, such as A5/1, for communications with the network.

As shown above, an undesirable cryptographic algorithm (e.g. A5/1) can be excluded from the first candidate list and, thus, the network element 200 will not select and use it for communications with the mobile terminal 100. If every mobile terminal has adopted the above-described embodiment, the undesirable cryptographic algorithm can be eliminated as long as the network has been upgraded to support stronger cryptographic algorithms. Although the attach procedure may be extended due to the re-attach with the second candidate list where the network has not been upgraded, the above-described embodiment is a pure terminal solution and no modifications need to be made on the network side.

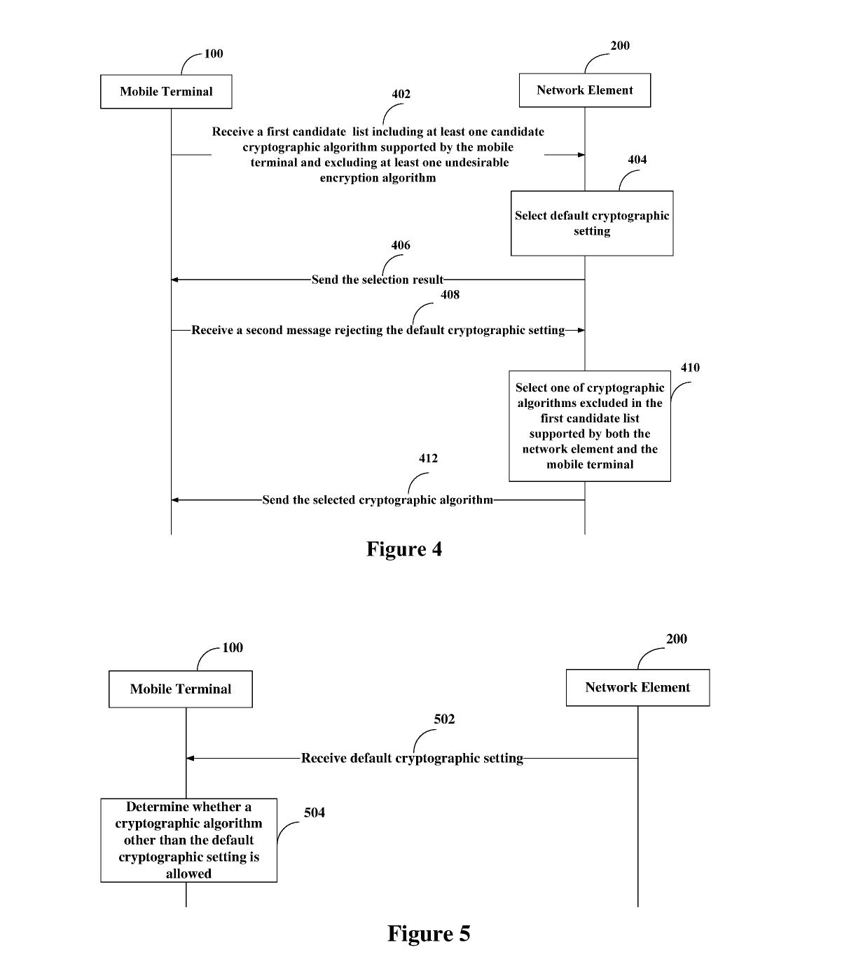

FIG. 4 is a diagram depicting the process of negotiating cryptographic algorithm in a wireless network according to another embodiment. As shown in FIG. 4, the process starts at step 402, wherein a mobile terminal 100 sends a first candidate list from the network element 200. The first candidate list includes at least one candidate cryptographic algorithm supported by the mobile terminal 100 and excludes at least one undesirable cryptographic algorithm even though it is supported by the mobile terminal 100. At step 404, the network element 200 attempts to select, from the first candidate list, a cryptographic algorithm supported by both the network element 200 and the mobile terminal 100. The steps of 402 and 404 in this embodiment are similar to steps 202 and 204 in FIG. 2 and steps 302 and 304 in FIG. 3.

However, in this embodiment, the network element 200 cannot find a cryptographic algorithm supported by both the network element and the mobile terminal at step 404, because the network does not support any cryptographic algorithm in the first candidate list. Similar to the embodiment described with FIG. 3, the network element 200 selects a default cryptographic setting when the network does not support any cryptographic algorithm in the first candidate list at step 404. Then at step 406, the network element 200 informs the mobile terminal 100 of the selection result.

When receiving the selection of default cryptographic setting, the mobile terminal 100 knows that the network element 200 does not support any cryptographic algorithm in the first candidate list. Thus, the mobile terminal 100 sends a message rejecting the default cryptographic setting to the network element 200 at step 408. In a GSM system, this can be done by sending a CIPHER MODE REJECT message with cause value “ciphering algorithm not supported” from the mobile terminal 100 to the network element 200.

When receiving the CIPHER MODE REJECT message from the mobile terminal 100, the network element 200 will determine whether the rejection is due to the requirement of eliminating an undesirable cryptographic algorithm, such as A5/1. This can be done by analyzing the first candidate list and interactions with the mobile terminal. For example, it can be assumed that the default cryptographic setting (e.g. A5/0) is supported by every mobile terminal. Thus, if the mobile terminal 100 rejects the assigned default cryptographic setting by sending back a CIPHER MODE REJECT message with cause value “ciphering algorithm not supported”, then the network element 200 can determine that this is because the mobile terminal 100 intends to eliminate an undesirable cryptographic algorithm, rather than not supporting the default cryptographic setting. That determination can be further supplemented by checking the first candidate list received from the mobile terminal 100 to see whether any undesirable cryptographic algorithm is excluded, for example, A5/1.

If it is determined that the rejection by the mobile terminal 100 is due to the requirement of eliminating an undesirable cryptographic algorithm, then at step 410 the network element 200 will select a cryptographic algorithm from the at least one undesirable cryptographic algorithm excluded from the first candidate list, which is supported by both the network element 200 and the mobile terminal 100, such as A5/1.

Then at step 412, the network element 200 sends the selection result to the mobile terminal 100. Thereafter, the mobile terminal 100 can use the selected cryptographic algorithm, such as A5/1, for communications with the network.

As shown above, an undesirable cryptographic algorithm (e.g. A5/1) can be excluded from the first candidate list and, thus, the network element 200 will not select and use it for communications with the mobile terminal 100. If every mobile terminal has adopted the above-described embodiments, the undesirable cryptographic algorithm can be eliminated as long as the network has been upgraded to support stronger cryptographic algorithms. Although the network element 200 needs to determine the intention of a rejection by the mobile terminal 100, the above-described embodiment can finish the cryptographic algorithm negotiation in one attach procedure.

FIG. 5 is a diagram depicting part of the process of negotiating cryptographic algorithm in a wireless network according to another embodiment. As shown in FIG. 5, at step 502, the network element 200 sends a message indicating a default cryptographic setting to the mobile terminal 100. As described in the above embodiments, this may happen: when the mobile terminal 100 sends a first candidate list from the mobile terminal 100 to the network element 200, wherein the first candidate list includes at least one candidate cryptographic algorithm supported by the mobile terminal 100 and excludes at least one undesirable cryptographic algorithm; but the network does not support any cryptographic algorithm in the first candidate list and, therefore, the network element 200 sends a message indicating the default cryptographic setting to the mobile terminal 100.

Upon receiving the message indicating the default cryptographic setting, the mobile terminal 100 determines whether any cryptographic algorithm other than the default cryptographic setting is allowed in the network, at step 504. This can be done by checking the network's regional information, such as mobile country code (MCC). It is know that some countries, such as China, prohibit GSM ciphering. In those networks, the mobile terminal 100 does not need to reject the network element's selection of default cryptographic setting, because there are no other options available. Accordingly, if it is determined that only the default cryptographic setting is allowed in the network, then the mobile terminal 100 may simply use the default cryptographic setting for communications with the network. In this way, the mobile terminal 100 can maximize security protection in a network that allows encryption; in the meantime it can also operate properly in those networks not allowing encryption.

According to another embodiment, the mobile terminal 100 can save the selection of cryptographic algorithm with respect to a network, so that later attach procedures can be simplified. For example, if the mobile terminal 100 knows that the network it is attaching to only supports an undesirable cryptographic algorithm (e.g. A5/1), then the mobile terminal 100 can include that undesirable cryptographic algorithm in the candidate list (e.g. security capability list) at the first attach attempt. Thus, the negotiation can be done on the first attempt and no re-attach procedure is necessary.

Furthermore, if the mobile terminal 100 knows that the network it is attaching to only supports a stronger cryptographic algorithm (e.g. A5/3), then the mobile terminal 100 can exclude the weaker, undesirable cryptographic algorithm in the candidate list (e.g. security capability list) at the first attach attempt, as shown in the embodiment described with FIG. 2. Thus, the mobile terminal 100 can achieve the maximum security protection on the first attempt and no re-attach procedure is necessary.

According to another embodiment, the mobile terminal 100 can update the selection of cryptographic algorithm after a predetermined period of time or at a certain interval. By way of example, the mobile terminal 100 can update the selection of cryptographic algorithm by perform a full negotiation once a week at night. In this way, the mobile terminal 100 can maximize the security protection if the network has been upgraded in the past week; meanwhile, this can minimize the impact of the updating process on battery consumption and user experience.

According to some embodiments, the undesirable cryptographic algorithm is weaker than those in the first candidate list; the default cryptographic setting is weaker than the undesirable cryptographic algorithm. The assessment of “weak” or “strong” can include various aspects, such as security level, power consumption, computing complexity, history of attacks, etc. For example, from perspective of the security level, the strengths may be ranked A5/0<A5/1<A5/3<A5/4. However, they may be ranked differently from other perspectives. It will be appreciated to those of ordinary skill in the art that there are other ways to define “weak” or “strong”.

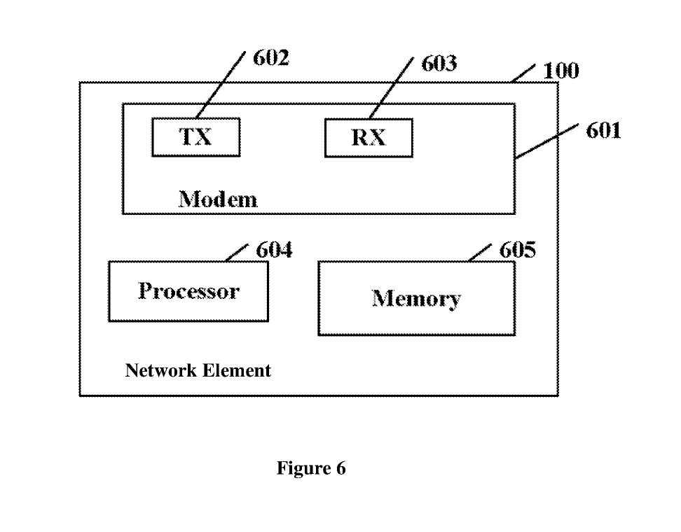

According to an aspect of the disclosure, it is provided a network element. FIG. 6 depicts a network element 200 useful in implementing the methods for cryptographic algorithm negotiation as described above. As shown in FIG. 6, the network element 200 comprises a processing device 604, a memory 605, and a radio modem subsystem 601 in operative communication with the processor 604. The radio modem subsystem 601 comprises at least one transmitter 602 and at least one receiver 603. While only one processor is illustrated in FIG. 6, the processing device 604 may comprises a plurality of processors or multi-core processor(s). Additionally, the processing device 604 may also comprise cache to facilitate processing operations.

Computer-executable instructions can be loaded in the memory 605 and, when executed by the processing device 604, cause the network element 200 to implement the above-described methods for cryptographic algorithm negotiation in the wireless network. In particular, the computer-executable instructions can cause the network element 200 to receive a first candidate from a mobile terminal, wherein the first candidate list includes at least one candidate cryptographic algorithm supported by the mobile terminal and excludes at least one undesirable cryptographic algorithm even though it is supported by the mobile terminal; send a first message indicating a default cryptographic setting to the mobile terminal when the network element does not support any cryptographic algorithm in the first candidate list; and send a third message to the mobile terminal after receiving a second message rejecting the default cryptographic setting from the mobile terminal, wherein the third message indicates a cryptographic algorithm selected from said at least one undesirable cryptographic algorithm excluded in the first candidate list that are supported by both the network element and the mobile terminal.

According to some embodiments, the undesirable cryptographic algorithm is weaker than those in the first candidate list; and the default cryptographic setting is weaker than the undesirable cryptographic algorithm.

According to an aspect of the disclosure it is provided a network element. The network element comprises: a receiving means configured to receive a first candidate from a mobile terminal, wherein the first candidate list includes at least one candidate cryptographic algorithm supported by the mobile terminal and excludes at least one undesirable cryptographic algorithm even though it is supported by the mobile terminal; a sending means configured to send a first message indicating a default cryptographic setting to the mobile terminal when the network element does not support any cryptographic algorithm in the first candidate list; and a resending means configured to send a third message to the mobile terminal after receiving a second message rejecting the default cryptographic setting from the mobile terminal, wherein the third message indicates a cryptographic algorithm selected from said at least one undesirable cryptographic algorithm excluded in the first candidate list that are supported by both the network element and the mobile terminal.

According to some embodiments, the undesirable cryptographic algorithm is weaker than those in the first candidate list; and the default cryptographic setting is weaker than the undesirable cryptographic algorithm.

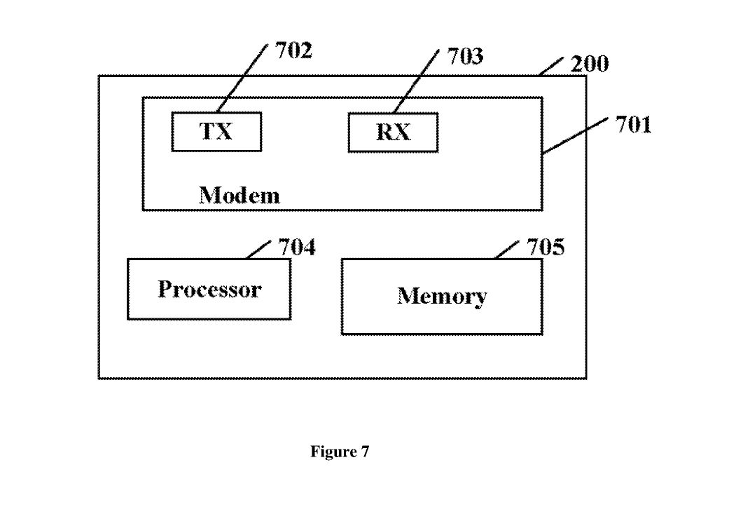

According to an aspect of the disclosure it is provided a mobile terminal. FIG. 7 depicts a mobile terminal 100 useful in implementing the methods for cryptographic algorithm negotiating as described above. As shown in FIG. 7, the mobile element 200 comprises a processing device 704, a memory 705, and a radio modem subsystem 701 in operative communication with the processor 704. The radio modem subsystem 701 comprises at least one transmitter 702 and at least one receiver 703. While only one processor is illustrated in FIG. 7, the processing device 704 may comprises a plurality of processors or multi-core processor(s). Additionally, the processing device 704 may also comprise cache to facilitate processing operations.

Computer-executable instructions can be loaded in the memory 705 and, when executed by the processing device 704, cause the mobile terminal 100 to implement the above-described methods for cryptographic algorithm negotiation in the wireless network. In particular, the computer-executable instructions can cause the mobile terminal 100 to: send a first candidate list to a network element, wherein the first candidate list includes at least one candidate cryptographic algorithm supported by the mobile terminal and excludes at least one undesirable cryptographic algorithm even though it is supported by the mobile terminal.

In an embodiment, the computer-executable instructions, when executed by the processing device 704, can further cause the mobile terminal to: receive a first message indicating a default cryptographic setting from the network element; and send a second message rejecting the default cryptographic setting to the network element.

In an embodiment, the computer-executable instructions, when executed by the processing device 704, can further cause the mobile terminal to: send a second candidate list including said at least one undesirable cryptographic algorithm to the network element, when receiving a first message indicating a default cryptographic setting from the network element.

In an embodiment, the computer-executable instructions, when executed by the processing device 704, can further cause the mobile terminal to: determine whether any cryptographic algorithm other than the default cryptographic setting is allowed in the network; and select the default cryptographic setting if no cryptographic algorithm other than the default cryptographic setting is allowed in the network.

In an embodiment, the computer-executable instructions, when executed by the processing device 704, can further cause the mobile terminal to: save the selection of cryptographic algorithm; and update the selection of cryptographic algorithm after a predetermined period of time.

In some embodiments, the undesirable cryptographic algorithm is weaker than those in the first candidate list; and the default cryptographic setting is weaker than the undesirable cryptographic algorithm.

According to an aspect of the disclosure it is provided a mobile terminal. The mobile terminal comprises: a sending means configured to send a first candidate list to a network element, wherein the first candidate list includes at least one candidate cryptographic algorithm supported by the mobile terminal and excludes at least one undesirable cryptographic algorithm even though it is supported by the mobile terminal.

In an embodiment, the mobile terminal further comprises: a receiving means configured to receive a first message indicating a default cryptographic setting from the network element; wherein the sending means is further configured to send a second message rejecting the default cryptographic setting to the network element.

In an embodiment, the sending means is further configured to send a second candidate list including said at least one undesirable cryptographic algorithm to the network element, when receiving a first message indicating a default cryptographic setting from the network element.

In an embodiment, the mobile terminal further comprises: a determining means configured to determine whether any cryptographic algorithm other than the default cryptographic setting is allowed in the network; wherein the mobile terminal is configured to select the default cryptographic setting if no cryptographic algorithm other than the default cryptographic setting is allowed in the network.

In an embodiment, the mobile terminal further comprises: a saving means configured to save the selection of cryptographic algorithm; and an updating means configured to update the selection of cryptographic algorithm after a predetermined period of time.

In some embodiments, the undesirable cryptographic algorithm is weaker than those in the first candidate list; and the default cryptographic setting is weaker than the undesirable cryptographic algorithm.

According to an aspect of the disclosure it is provided a system for cryptographic algorithm negotiating in a wireless network, comprising an above-described network element; and at least one above-described mobile terminal.

According to an aspect of the disclosure it is provided a computer program product comprising at least one non-transitory computer-readable storage medium having computer-executable program instructions stored therein, the computer-executable instructions being configured to, when being executed, cause a network element to operate as described above.

According to an aspect of the disclosure it is provided a computer program product comprising at least one non-transitory computer-readable storage medium having computer-executable program instructions stored therein, the computer-executable instructions being configured to, when being executed, cause a mobile terminal to operate as described above.

It is noted that any of the components of the network element and mobile element can be implemented as hardware or software modules. In the case of software modules, they can be embodied on a tangible computer-readable recordable storage medium. All of the software modules (or any subset thereof) can be on the same medium, or each can be on a different medium, for example. The software modules can run, for example, on a hardware processor. The method steps can then be carried out using the distinct software modules, as described above, executing on a hardware processor.

The terms “computer program”, “software” and “computer program code” are meant to include any sequences or human or machine cognizable steps which perform a function. Such program may be rendered in virtually any programming language or environment including, for example, C/C++, Fortran, COBOL, PASCAL, assembly language, markup languages (e.g., HTML, SGML, XML), and the like, as well as object-oriented environments such as the Common Object Request Broker Architecture (CORBA), Java™ (including J2ME, Java Beans, etc.), Binary Runtime Environment (BREW), and the like.

The terms “memory” and “storage device” are meant to include, but not limited to, an electronic, magnetic, optical, electromagnetic, infrared, or semiconductor system, apparatus, or device, or any suitable combination of the foregoing. More specific examples (a non-exhaustive list) of the memory or storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1-32. (canceled)

33. A method for cryptographic algorithm negotiation between a network element and a mobile terminal, comprising:
receiving a first candidate list from the mobile terminal by the network element, wherein the first candidate list includes at least one candidate cryptographic algorithm supported by the mobile terminal and excludes at least one undesirable cryptographic algorithm even though it is supported by the mobile terminal; and
selecting, from the first candidate list, a cryptographic algorithm supported by both the network element and the mobile terminal.

34. The method according to claim 33, wherein the network element does not support any cryptographic algorithm in the first candidate list, and the method further comprises:
sending a first message indicating a default cryptographic setting from the network element to the mobile terminal; and
receiving a second message rejecting the default cryptographic setting from the mobile terminal by the network element.

35. The method according to claim 34, further comprising:
receiving a second candidate list including said at least one undesirable cryptographic algorithm from the mobile terminal by the network element; and
selecting, from the second candidate list, a cryptographic algorithm supported by both the network element and the mobile terminal.

36. The method according to claim 34, further comprising:
selecting a cryptographic algorithm from said at least one undesirable cryptographic algorithm excluded in the first candidate list that are supported by both the network element and the mobile terminal; and
sending a third message indicating the selected undesirable cryptographic algorithms from the network element to the mobile terminal.

37. The method according to claim 34, wherein the mobile terminal is able to determining whether any cryptographic algorithm other than the default cryptographic setting is allowed in the network before sending the second message; and the method further comprises:
selecting the default cryptographic setting if no cryptographic algorithm other than the default cryptographic setting is allowed in the network.

38. The method according to claim 33, wherein the mobile terminal is able to:
save the selection of cryptographic algorithm; and
update the selection of cryptographic algorithm after a predetermined period of time.

39. The method according to claim 33, wherein the undesirable cryptographic algorithm is weaker than those in the first candidate list.

40. The method according to claim 33, wherein the default cryptographic setting is weaker than the undesirable cryptographic algorithm.

41. The method according to claim 33, further comprising: updating designation of the undesirable cryptographic algorithm.

42. A network element comprising:
at least one processor; and
at least one memory including computer program code,
wherein the at least one memory and the computer program code are configured to, with the at least one processor, cause the network element to:
receive a first candidate from a mobile terminal, wherein the first candidate list includes at least one candidate cryptographic algorithm supported by the mobile terminal and excludes at least one undesirable cryptographic algorithm even though it is supported by the mobile terminal;
send a first message indicating a default cryptographic setting to the mobile terminal if the network element does not support any cryptographic algorithm in the first candidate list; and
send a third message to the mobile terminal after receiving a second message rejecting the default cryptographic setting from the mobile terminal, wherein the third message indicates a cryptographic algorithm selected from said at least one undesirable cryptographic algorithm excluded in the first candidate list, which is supported by both the network element and the mobile terminal.

43. The network element according to claim 42, wherein the undesirable cryptographic algorithm is weaker than those in the first candidate list.

44. The network element according to claim 42, wherein the default cryptographic setting is weaker than the undesirable cryptographic algorithm.

45. A mobile terminal comprising:
at least one processor; and
at least one memory including computer program code,
wherein the at least one memory and the computer program code are configured to, with the at least one processor, cause the mobile terminal to:
send a first candidate list to a network element, wherein the first candidate list includes at least one candidate cryptographic algorithm supported by the mobile terminal and excludes at least one undesirable cryptographic algorithm even though it is supported by the mobile terminal.

46. The mobile terminal according to claim 45, wherein the at least one memory and the computer program code are further configured to, with the at least one processor, cause the mobile terminal to:
receive a first message indicating a default cryptographic setting from the network element; and
send a second message rejecting the default cryptographic setting to the network element.

47. The mobile terminal according to claim 45, wherein the at least one memory and the computer program code are further configured to, with the at least one processor, cause the mobile terminal to:
send a second candidate list including said at least one undesirable cryptographic algorithm to the network element, when receiving a first message indicating a default cryptographic setting from the network element.

48. The mobile terminal according to claim 45, wherein the at least one memory and the computer program code are further configured to, with the at least one processor, cause the mobile terminal to:
determine whether any cryptographic algorithm other than the default cryptographic setting is allowed in the network; and
select the default cryptographic setting if no cryptographic algorithm other than the default cryptographic setting is allowed in the network.

48. The mobile terminal according to claim 45, wherein the at least one memory and the computer program code are further configured to, with the at least one processor, cause the mobile terminal to:
save the selection of cryptographic algorithm; and
update the selection of cryptographic algorithm after a predetermined period of time.

50. The mobile terminal according to claim 45, wherein the undesirable cryptographic algorithm is weaker than those in the first candidate list.

51. The mobile terminal according to claim 45, wherein the default cryptographic setting is weaker than the undesirable cryptographic algorithm.
